(19) United States
(12) Patent Application Publication
(10) Pub. No.: US 2002/0198780 A1
(43) Pub. Date: Dec. 26, 2002

(54) Multimedia content distributing system, content distributing method and computer program thereof

(75) Inventors: Hiroyuki Kawakami, Tokyo (JP); Satoshi Hasegawa, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/171,778

(22) Filed: Jun. 17, 2002

(30) Foreign Application Priority Data
Jun. 20, 2001 (JP) 2001-186050

(51) Int. Cl. G06F 17/60

(52) U.S. Cl. 705/14

(57) ABSTRACT

In the multimedia content distribution system using a network, a relay server is provided between a content server and a user terminal. The relay server is controlled so as to transmit the first multimedia content stored in the first content storing means to the user terminal in a case in which the monitoring means detects that a data amount of the first content is beyond a predetermined amount, and further controlled so as to transmit the second content stored in the second content storing means to the user terminal in a case in which the monitoring means detects that a data amount of the first content stored in the first content storing means is less than the predetermined amount.

### BACKGROUND OF THE INVENTION

1. Field of the Invention

The present invention relates to streaming distribution of multimedia content via communication networks. More specifically, the present invention relates to a content distribution system, a distribution method thereof and distribution controlling program for performing distribution with advertisement content efficiently inserted therein.

2. Description of Related Art

Streaming is a technique for receiving multimedia content such as music and video distributed on the Internet and playing the same in real time. In the streaming, files are not downloaded on a hard disk before being played, but content data are received and simultaneously played in real time. Thus the streaming has advantages in that there occur no wait time for downloading and no limitation imposed by free area of the hard disk.

In order to perform streaming distribution, it is necessary that line speed is higher than amount of data to be used in playing per hour. In addition, multimedia content of video and music or the like is large volumetric and many current Internet lines in general are low in speed. Hence, real-time transmission is achieved generally by compressing the date by use of various CODEC formats.

Conventional arts for handling failures in the case of delay in data transfer include a system such that a content server dynamically determines the maximum bandwidth usable for transfer, according to the communication quality provided by communication networks. Specifically, when a communication band is lowered in course of communicating or data transfer is delayed, image quality and display size of video content are automatically reduced, thereby suppressing time-length and number of times of interruption or the like in video playing.

As described in the above, the conventional arts has problems as follows.

In the conventional arts, when the communication quality provided by communication networks of the Internet or the like is lowered or data transfer rate is lowered, quality and display size of video content are automatically reduced. Users are not quite satisfied with the quality and display size being lowered during playback. Particularly, the lowered quality and display size are not preferable for use in distribution of pay content.

Further, conventionally, there was no effective system for providing users with advertisements carried out in streaming distribution. As systems for providing advertisements to users, for example, it is possible to display banner advertisements around a (video) image playing area on display screen image. However, in such a system for displaying distributed content and advertisements simultaneously, interests of users focus on the distributed image content, not sufficiently directed to the banner advertisements, or even users might think the banner advertisements unpleasant to the eye, in viewing the image content.

A first object of the invention is to overcome the above-mentioned defects, and to provide a multimedia content distribution system, a content distribution method and content distribution program for distributing a large volume of content such as image content efficiently and displaying advertisements on a user terminal of a user properly in a broadband communication band and even in communication networks in which the quality can not be stably assured.

A second object of the invention is to overcome the defects, and to provide a content distribution system, a content distribution method and content distribution program for playing distributed content, for example image content, without decrease in quality and error by storing the content to be distributed, and by making a user terminal play previously-prepared advertisement when a stored amount of the content to be distributed is not enough, and for providing advertisement content efficiently.

### SUMMARY OF THE INVENTION

To achieve the above-noted object, the present invention adopts the following basic technical constitution.

The first aspect of the present invention is a multimedia content distribution system in which a multimedia content requested from a user terminal is distributed from a content server to the user terminal, wherein the system having a relay server which receives a first multimedia content distributed from the content server in accordance with a request from the user terminal and transmits the received first content to the user terminal; the relay server comprising: a first content storing means for temporally storing the first content received from the content server; a monitoring means for monitoring whether or not a data amount of the received first content stored in the first content storing means is beyond a predetermined data amount; a second content storing means having a second multimedia content at least including an advertising content; and a control means for controlling the relay server so as to transmit the first content stored in the first content storing means to the user terminal in a case in which the monitoring means detects that a data amount of the first content is beyond a predetermined amount, and controlling the relay server so as to transmit the second content stored in the second content storing means to the user terminal in a case in which the monitoring means detects that a data amount of the first content stored in the first content storing means is less than the predetermined amount.

In the second aspect of the present invention, the relay server further comprising a scheduler for managing distribution of the second content stored in the second content storing means, the control means transmits the second content to the user terminal in accordance with an instruction output from the scheduler.

In the third aspect of the present invention, the relay server further comprising a scheduler for managing distribution of the second content stored in the second content storing means, the control means transmits regularly the second content to the user terminal in accordance with an instruction output from the scheduler.

In the fourth aspect of the present invention, the relay server and the user terminal are connected via a local area network.

The fifth aspect of the present invention is a multimedia content receiving system in which a user terminal receives multimedia content distributed from a content server in accordance with a request from the user terminal, the user terminal comprising: a first content storing means for temporally storing a first multimedia content received from the content server; a monitoring means for monitoring whether or not a data amount of the received first content stored in the first content storing means is beyond a predetermined data amount; a second content storing means for storing a second multimedia content at least including an advertising content; and a control means for controlling the user terminal so as to display the first content stored in the first content storing means on the user terminal in a case in which the monitoring means detects that a data amount of the first content is beyond a predetermined amount, and controlling the user terminal so as to display the second content stored in the second content storing means on the user terminal in a case in which the monitoring means detects that a data amount of the first content stored in the first content storing means is less than the predetermined amount.

### BRIEF DESCRIPTION OF THE DRAWINGS

FIG. 1 is a block diagram showing a configuration of a content distribution system according to a first embodiment of the present invention;

FIG. 2 is a flowchart for explaining processing of providing advertisement content according to the first embodiment of the present embodiment;

FIG. 3 is a block diagram illustrating a content distribution system according to a second embodiment of the present invention;

FIG. 4 is a block diagram illustrating a content distribution system according to a third embodiment of the present invention;

FIG. 5 is a block diagram illustrating a content distribution system according to a fourth embodiment of the present invention;

FIG. 6 is a flowchart for explaining processing of providing advertisement content according to the fourth embodiment of the present embodiment;

FIG. 7 is a block diagram illustrating a content distribution system according to a fifth embodiment of the present invention;

FIG. 8 is a block diagram illustrating a content distribution system according to a sixth embodiment of the present invention; and

FIG. 9 is a flowchart for explaining processing of providing advertisement content according to a seventh embodiment of the present embodiment.

### DETAILED DESCRIPTION OF THE PREFERRED EMBODIMENTS

Detailed description of embodiments of the present invention will be given below with reference to drawings.

First, the summery of the present invention will be described. A content distribution system of the present invention is characterized in that content such as video to be distributed (distribution content) from the content server is stored, for example, in the relay server, and when an amount of content to be distributed from the relay server is not enough, content previously stored and prepared (interval content) is transmitted to the user terminal. Thus, the distribution content is played without causing decrease in image quality and errors, and interval content such as advertisements can be efficiently provided.

Here in this specification, explanation is given using examples in which distribution content to be distributed from a content server is image content and interval content to be played between distribution content is advertisement content which displays (image of) advertisements. However, the present invention is not limited to these examples. For instance, as interval content, content such as music and voice can be applied. In addition to the advertisements, news, weather forecasting or the like provided by a sponsor can be applied.

It is possible to perform processing of content distribution (specifically, processing for storing image content, processing for switching playback of image content and playback of advertisement content which is played between image contents) at various points in communication networks, as described below. For example, with a relay server provided between a content server which distributes content and a user terminal of a user, it is possible to perform content distribution of the present invention. Additionally, it is possible to perform content distribution in user terminals.

In other words, in the relay server or the user terminal, advertisement content is stored in advance. When a streaming service is launched to users, first image content to be distributed from the content server is received and stored, and the advertisement content is played at user terminals until it reach a predetermined sufficient amount of storage of image content.

Then, during the user terminals playing the advertisement content, image content is stored. When a stored amount of the image content is equal to or more than a reference value, content to be played at the user terminal is switched to the image content stored in the relay server or the user terminal.

In addition, in a case in which image content is played at a user terminal, when the communication speed with the content server is low, the amount of the image content stored in a buffer provided in the relay server or the user terminal becomes reduced, therefore, it is difficult to play the image content. For this reason, in the present invention, data amount stored in the buffer is always monitored after playback of the image content starts, and if necessary (or regularly), content tone displayed at the user terminal is switched to advertisement content. During this time, the amount of stored image content is increased. After the amount becomes equal to or more than a reference value, the image content is played at the user terminal again.

Here, when content to be played is switched from advertisement content to image content, the switching to the image content may be executed after playback of the advertisement content terminates, so as to prevent playback of the advertisement content from being interrupted.

In this manner, advertisement content and image content to be displayed at a user terminal are switched and displayed repeatedly, thereby making it possible to play the image content (with advertisement content interposed), without sudden interruption of the played content, even if the communication speed with a content server is low.

Additionally, this switching of advertisement content and image content may be performed not only where the communication speed is low but also where a communication speed enough high for streaming distribution is prepared. Here, when the enough high communication speed is prepared, there occurs no problem such that image content stored in a buffer is falling short in course of playback. Thus, the switching processing of played content can be executed, for example, at given time intervals.

Thus, in a case in which switching from image content to advertisement content is caused at predetermined time intervals, the played image content is not suddenly switched, and a user is informed of the switching of played content in advance, thereby alleviating discontent of interrupting of the played image content.

(First Embodiment)

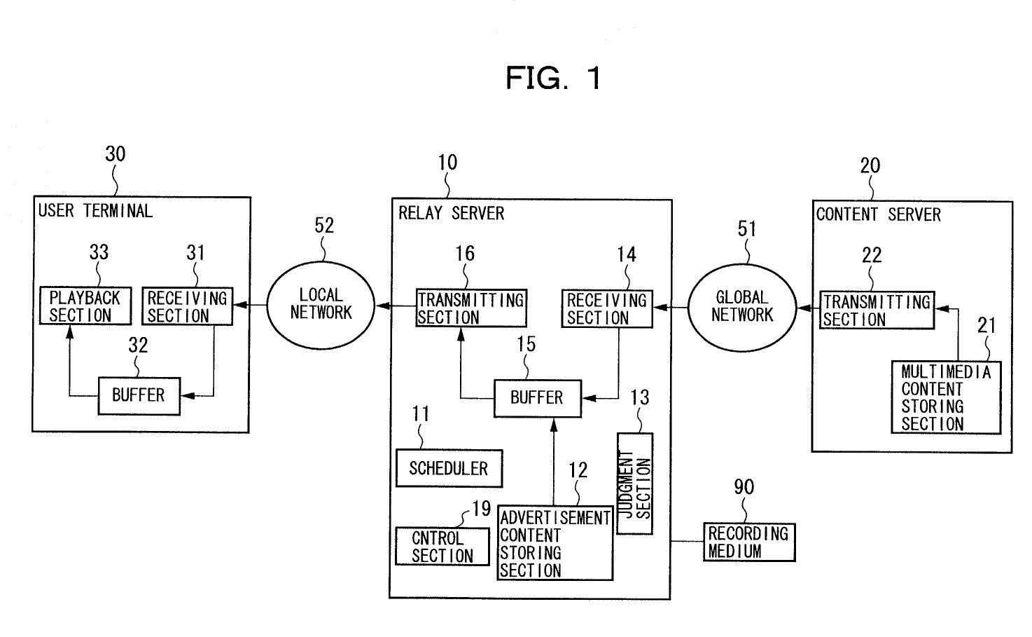

FIG. 1 is a block diagram showing a configuration of a content distribution system according to a first embodiment of the present invention. Referring FIG. 1, in a content distribution system of the first embodiment, a relay server 10 is provided between a content server 20 which distributes content and a user terminal 30 of a user. The aforementioned processing such as storing of image content and switching of played content is executed by the relay server 10.

Also, in FIG. 1, the user terminal 30 and the relay server 10 are connected by a local network 52 in which a communication speed enough high for streaming is prepared, while the relay server 10 and the content server 20 are connected by a global network 51 such as Internet in which sufficient communication speed is obtained.

The user terminal 30 is an information processing equipment of a personal computer or the like. The user terminal 30 has a function of accessing the content server 20 via the relay server 10 and downloading image content to play.

The relay server 10 comprises: a receiving section 14 for receiving image content from the content server 20; a buffer 15 for storing received image content; a transmission section 16 for transmitting stored content to the user terminal 30; a judgment section 13 for monitoring data amount of the stored image content in the buffer 15 and determining whether or not the stored amount is enough; and a scheduler 11 for managing a playback time of the content and controlling switching of content to be played.

The content server 20 comprises an image content storing section 21 for storing various image contents, and transmitting section 22 for transmitting the image content to the relay server 10 via the global network 51 based on a request from the user terminal 30 or the relay server 10.

In the first embodiment of the present invention, the image content is distributed via the global network 51 (for example, where communication quality is not assured) from the content server 20, then temporarily stored in the buffer 15 provided within the relay server 10, and transferred to the user terminal 30 via the local network 52 (for example, where communication quality is assured) from the relay server 10.

The relay server 10 stores in advance advertisement content in the advertisement content storing section 12, and based on launch of a streaming service of image content, transmits advertisement content stored in the advertisement content storing section 12 to the user terminal 30. On the other hand, during the playback of the advertisement content on the user terminal 30, the relay server 10 receives image content from the content server 20 via the global network 51 and stores the same in the buffer 15. The judgment section 13 always monitors the amount of stored content during the storing of the image content, the judgment section 13 determines whether or not the stored amount is equal to or more than a predetermined reference value.

In this first embodiment, when the judgment section 13 detects that the amount of the stored image content is equal to or more than a reference value, and display time determined for advertisement content in course of playback terminates, content to be played by the user terminal 30 is switched to the image content from the advertisement content. In this manner, the content to be transferred to the user terminal 30 is switched.

The display time determined for advertisement content in course of playback is managed by the scheduler 11. Further, when display time determined for advertisement content in course of playback terminates and the amount of the image content is not enough stored at that time, the relay server 10 continuously transmits the same or other advertisement content to the user terminal 30.

Also, switching from the image content to the advertisement content is carried out, not only when a streaming service is launched, but also on regular basis (or based on the stored amount of image content). During the distribution of advertisement content, the relay server 10 continues to download the image content, thereby obtaining the prescribed amount of the image content. This makes it possible to display the image content with high quality and also the advertisement content with high quality.

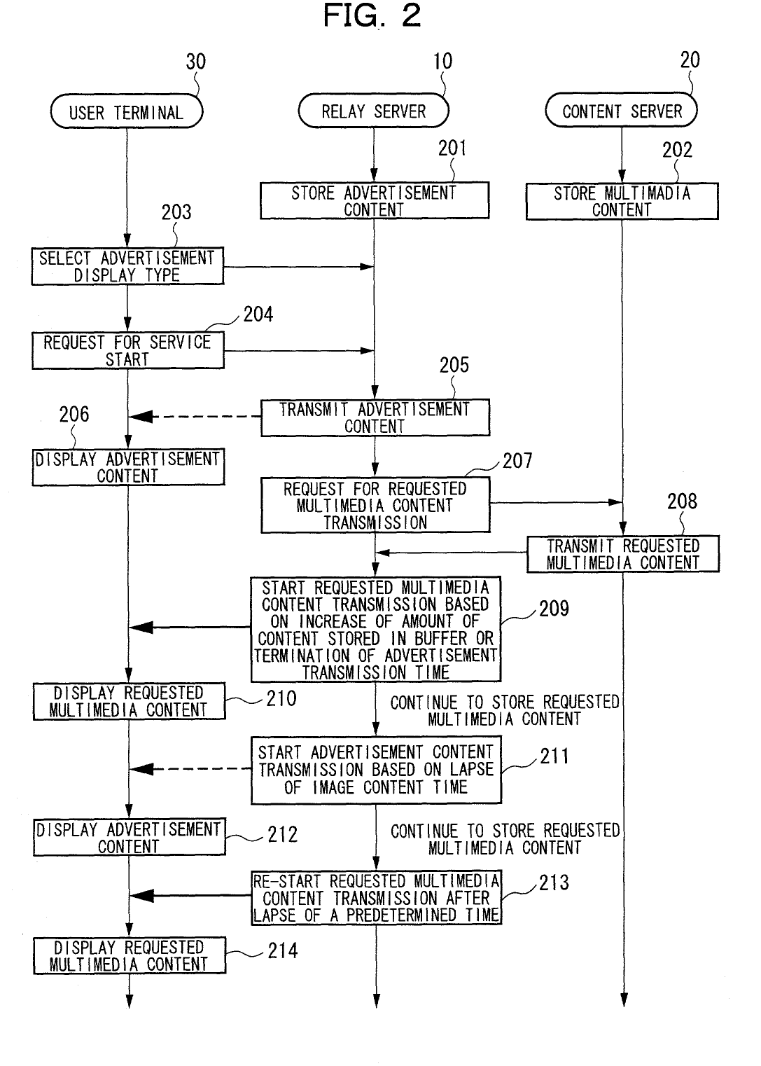

Next, operations of the first embodiment are described in detail with reference to the figure, below. FIG. 2 is a flowchart for explaining advertisement content providing processing according to the first embodiment of the present invention.

Referring to FIG. 2, the relay server 10 has data of advertisement content previously stored in the advertisement content storing section 12 (step 201), and the content server 20 has data of various image content within the image content storing section 21 (step 202).

First, a user designates and registers an advertisement display type from the user terminal 30 to the relay server 10 (step 203). Here the advertisement display type is thought to include a banner display type, a type such that a display size and quality are lowered without displaying advertisement content. The user selects an advertisement display type and informs the relay server 10 to register the type. In addition, instead of the user to selects a type, a system administrator may set up a display type in advance uniformly for each relay server.

Hereafter is described processing in which an advertisement display type such that image content and advertisement content are alternatively switched to be displayed is designated. Next, the user transmits a service starting request of image content distribution from the user terminal 30 to the relay server 10 (step 204). When the relay server 10 receives the service starting request, the relay server transmits to the user terminal 30 previously-stored advertisement content and makes the user terminal to display the content (step 205, step 206).

At the same time, the relay server 10 requests the content server 20 to transmit image content (step 207). When the content server 20 receives a transmission request, the content server 20 transmits the image content to the relay server 10 via the global network 51 (step 208).

Then, after the amount of the image content, received from the content server 20, stored in the buffer 15 reaches a predetermined value, and when the relay server 10 terminates playback of the advertisement content, the relay server 10 starts to transmit the image content stored in the buffer 15 to the user terminal 30 (step 209). Thereby, the user terminal 30 receives the image content and starts playback of the image content (step 210).

Further, during transmission of the image content, based on the control of the scheduler 11 which manages a transmission time of the advertisement content, transmission of the image content is switched to transmission of the advertisement content to display the advertisement content (step 211, step 212).

Here, the switching from image content to advertisement content can be performed when the data amount of the stored image content is less than a predetermined data amount (or the stored data falls short), where predetermined time (such as 5 minutes or 10 minutes) lapses, or when a predetermined time point comes for transmitting the advertisement content (that is, a time point appropriate for interrupting the image contents, as in a TV commercial message in a TV program) or by combination of these cases.

The relay server 10 continuously downloads the image content from the content server 20 during the transmission of the advertisement. When the scheduler 11 for managing the advertisement content transmission time terminates the display of the advertisement content, after the amount of the image content stored in the buffer 15 reaches a predetermined value, the relay server 10 starts to transfer the image content and makes the user terminal 30 to play the image content again (step 213, step 214)

Further, the number of the relay server 10 of the present embodiment does not limit to one user terminal 30 to which content is distributed by the relay server 10. The relay server 10 may carry out the processing of the present embodiment to each of a plurality of user terminals 30 in parallel. Also, the content server 20 from which content is distributed is not limited to one content server.

Further, it is possible to provide the relay server used as a mirror server which performs local-caching only popular content to be distributed from the content server 20.

As described above, according to the content distribution system of the first embodiment, the relay server 10 stores the image content to be distributed to the user terminal 30. When the amount of the image content stored in the buffer 15 is not enough, the relay server 10 transmits the previously-stored advertisement content to the user terminal. As a result, it is possible to play the image content without decrease in image quality and without error, and to provide the advertisement content to the user efficiently.

For this reason, advertisements may be provided efficiently to many users. In other words, it is easy to reserve a time for inserting advertisement content between image contents to be distributed to the users. In addition, by using a type such that advertisement content stored in the relay server is displayed, it is easy to display large volume of advertisement content with whole the screen utilized, thereby realizing the same advertising effects as those shown in cinemas.

Here, an advertising provider for providing advertisement content of this embodiment can be charged, in whole or in part, a fee required for the user to receive an image content service from the content server 20. Thereby, the user can utilize image content at a low price or no charge on condition that he receives advertisements distribution.

For this reason, in the case in which the advertising provider is charged the fee, not only a user who utilizes a slow communication line but also a user who utilizes an enough-high-speed communication line can use the content distribution system of the present embodiment at a low price.

For the user who utilizes a high-speed communication line, switching from the image content to advertisement content and/or from the advertisement content to image content is not performed based on the amount of the image content stored in the buffer, but performed regularly at predetermined time intervals (or based on switching time predetermined for respective relayed image content).

As described above the first embodiment of the present invention is a multimedia content distribution system in which a multimedia content requested from a user terminal is distributed from a content server to the user terminal, wherein the system having a relay server 10 which receives a first multimedia content distributed from the content server 20 in accordance with a request from the user terminal 30 and transmits the received first content to the user terminal 30; the relay server 10 comprising: a first content storing means 15 for temporally storing the first content received from the content server 20; a monitoring means 13 for monitoring whether or not a data amount of the received first content stored in the first content storing means is beyond a predetermined data amount; a second content storing means 12 having a second multimedia content at least including an advertising content; and a control means 19 for controlling the relay server 10 so as to transmit the first content stored in the first content storing means 15 to the user terminal 30 in a case in which the monitoring means 13 detects that a data amount of the first content is beyond a predetermined amount, and controlling the relay server 10 so as to transmit the second content stored in the second content storing means 12 to the user terminal 30 in a case in which the monitoring means 13 detects that a data amount of the first content stored in the first content storing means is less than the predetermined amount.

(Second Embodiment)

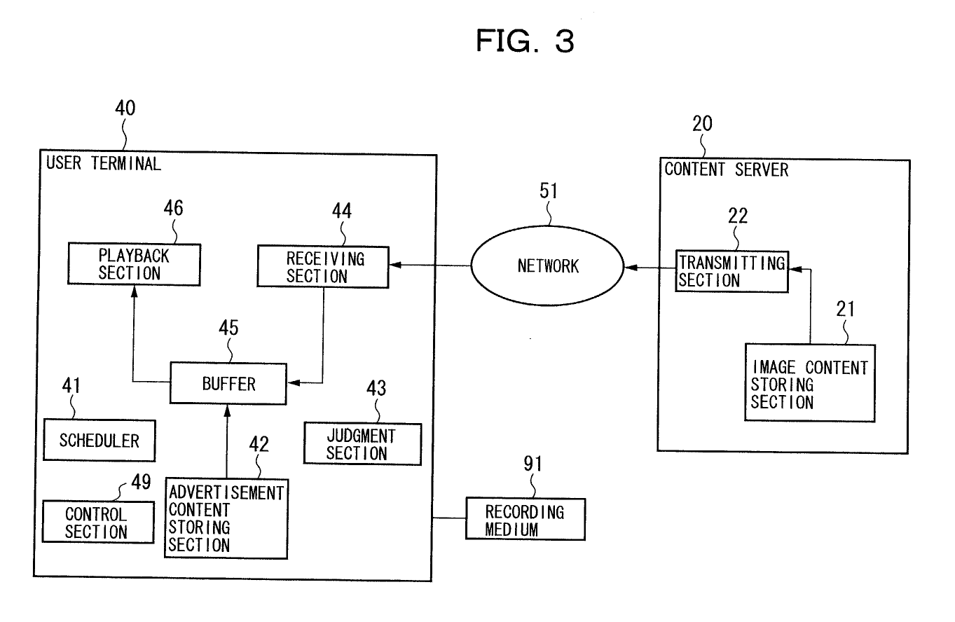

Next, the second embodiment of the present invention is described. FIG. 3 is a block diagram illustrating a content distribution system according to the second embodiment of the present invention. In this embodiment, a user terminal 40 has a function of the relay server 10 of the first embodiment, and executes the aforementioned processing of storing of image content and switching of played content.

In addition, like the relay server 10 of the first embodiment, the user terminal 40 of the present embodiment comprises the advertisement content storing section 42, a judgment section 43, a scheduler 41 for selecting and switching the played content and buffer 45 for storing the image content. Processing of the judgment section 43 and scheduler 41 provided in the user terminal 40 of the second embodiment is the same as that of the judgment section 13 and scheduler 11 in the relay server 10 of the first embodiment.

Specifically, the scheduler 41 provided in the user terminal 40 of the second embodiment controls switching of the display of the advertisement content stored in the advertisement content storing section 42 and the image content stored in the buffer 45 which is transferred via a global network 51, based on a designated advertisement display time and the amount of the image content stored in a buffer 45.

As described above the second embodiment of the present invention is a multimedia content receiving system in which a user terminal 40 receives multimedia content distributed from a content server 20 in accordance with a request from the user terminal, the user terminal 40 comprising: a first content storing means 45 for temporally storing a first multimedia content received from the content server 20; a monitoring means 43 for monitoring whether or not a data amount of the received first content stored in the first content storing means 45 is beyond a predetermined data amount; a second content storing means 42 for storing a second multimedia content at least including an advertising content; and a control means 49 for controlling the user terminal 40 so as to display the first content stored in the first content storing means 45 on the user terminal in a case in which the monitoring means 43 detects that a data amount of the first content is beyond a predetermined amount, and controlling the user terminal so as to display the second content stored in the second content storing means 42 on the user terminal in a case in which the monitoring means 43 detects that a data amount of the first content stored in the first content storing means is less than the predetermined amount.

(Third Embodiment)

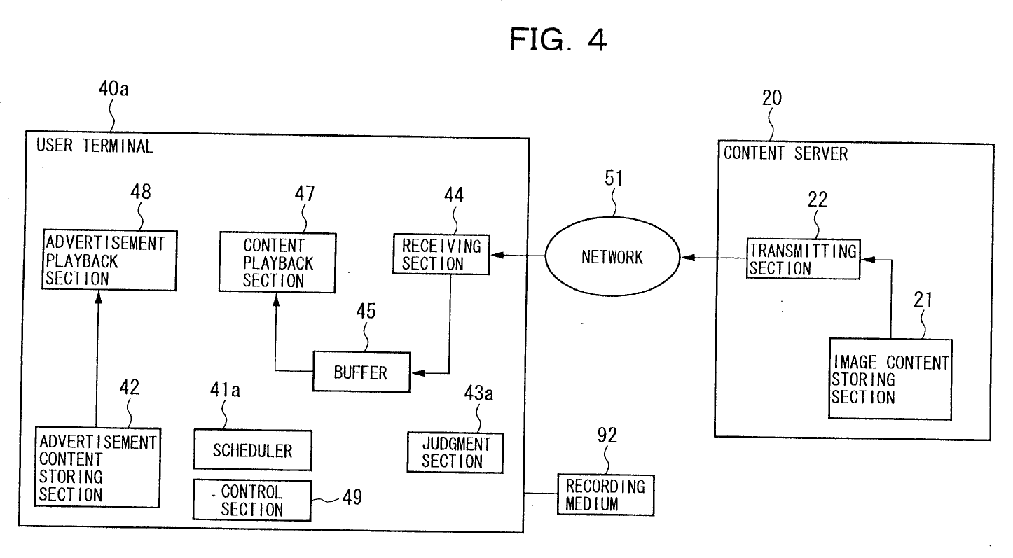

Next, a third embodiment of the present invention is described. FIG. 4 is a block diagram illustrating a content distribution system according to the third embodiment of the present invention. In this embodiment, a user terminal 40a comprises an advertisement displaying section 48 which is a displaying section dedicated for displaying the advertisement content stored in the advertisement content storing section 42. That is, in the third embodiment, it is assumed that the image content and advertisement content are displayed using respective different applications.

The scheduler 41a provided in the user terminal 40a of the third embodiment controls switching of the display of the advertisement content stored in the advertisement content storing section 42 and the image content stored in the buffer 45 which is transferred via a global network 51, based on a designated advertisement display time and the amount of the image content stored in a buffer 45.

The same effects as those in the first embodiment are expected in the aforementioned second and third embodiments of the present invention. Further, the second and third embodiments of the present invention can be carried out by providing the aforementioned function of the present invention within the user terminal, therefore it is not necessary to place the relay server on the communication network.

Next, fourth to sixth embodiments of the present invention are described.

In the aforementioned first to third embodiments, the switching of played content is carried out based on not only the amount of the image content stored in the buffer, but also playback times of respective contents which are monitored by the schedulers 11, 41 and 41a respectively. Meanwhile in the fourth to sixth embodiments, the switching of played content is controlled based on the amount of stored image content only. Therefore, in the fourth to sixth embodiments, the simple configuration is obtained.

(Fourth Embodiment)

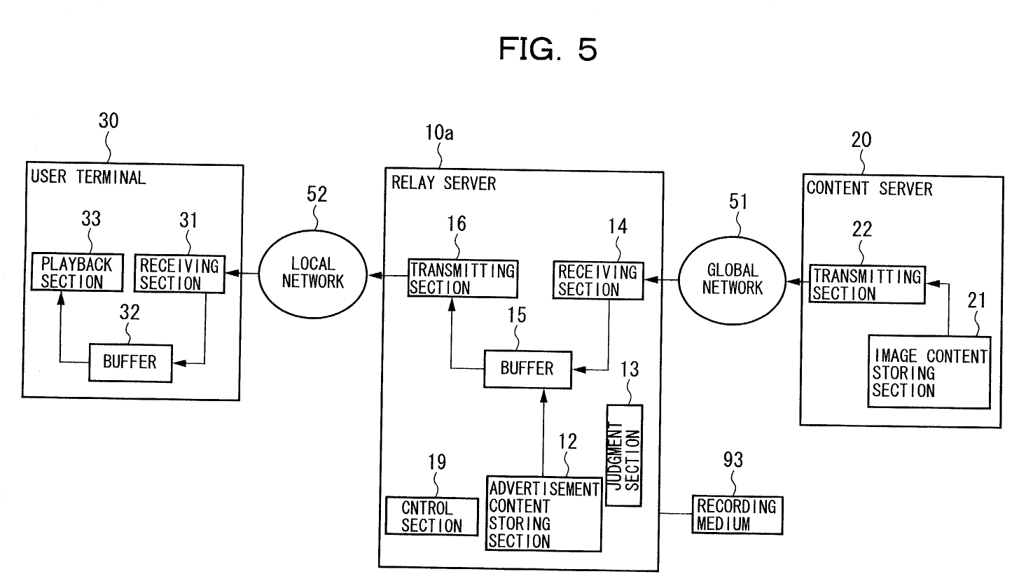

FIG. 5 is a block diagram illustrating a content distribution system according to a fourth embodiment of the present invention. Referring to FIG. 5, the content distribution system of the fourth embodiment, as is the case with the first embodiment, comprises a relay server 10a provided between a content server 20 which distributes content and a user terminal 30 of a user. By using the relay server 10a, processing such as storing of image content and switching of played content is executed.

Also in FIG. 5, the user terminal 30 and the relay server 10a are connected by a local network 52 in which a communication speed enough high for streaming is prepared, while the relay server 10a and the content server 20 are connected by a global network 51 such as Internet in which sufficient communication speed is obtained.

The user terminal 30 is an information processing equipment of a personal computer or the like. The user terminal 30 has a function of accessing the content server 20 via the relay server 10a and downloading image content to play from the relay server 10a.

The relay server 10a comprises: a receiving section 14 for receiving image content from the content server 20; a buffer 15 for storing image content received from the content server 20; a transmission section 16 for transmitting stored content to the user terminal 30; and a judgment section 13 for monitoring data amount of the image content stored in the buffer 15 and judging whether or not the amount of the image content stored in the buffer 15 is enough. The relay server 10a also controls switching of content to be played by the user terminal 30, based on the judgment whether or not the amount of the image content stored in the buffer 15 is enough.

The content server 20 comprises an image content storing section 21, and the transmitting section 22 transmits the image content to the relay server 10 via the global network 51 based on a request from the user terminal 30 or the relay server 10.

In the fourth embodiment of the present invention, the image content is distributed via the global network 51 (for example, where communication quality is not assured) from the content server 20, then temporarily stored in the buffer 15 provided within the relay server 10a, and transferred to the user terminal 30 via the local network 52 (for example, where communication quality is assured) from the relay server 10.

The relay server 10 stores in advance advertisement content in the advertisement content storing section 12, and based on launch of a streaming service of image content, transmits advertisement content stored in the advertisement content storing section 12 to the user terminal 30. On the other hand, during the playback of the advertisement content on the user terminal 30, the relay server 10 receives image content from the content server 20 via the global network 51 and stores the same in the buffer 15. The judgment section 13 always monitors the amount of stored content during the storing of the image content, the judgment section 13 determines whether or not the stored amount is equal to or more than a predetermined reference value.

In the fourth embodiment, when the judgment section 13 detects that the amount of the image content stored in the buffer 15 is equal to or more than a reference value, content to be displayed on the user terminal 30 is switched to the image content by the control of the judgment section 13. In this manner, the content to be transferred to the user terminal 30 is switched from the advertisement content to the image content.

Also, switching from the image content to the advertisement content is carried out not only when a streaming service is launched, but also carried out based on the stored amount of image content. During the distribution of advertisement content, the relay server 10a continues to download the image content, thereby obtaining the prescribed amount of the image content. This makes it possible to display the image content with high quality and also the advertisement content with high quality.

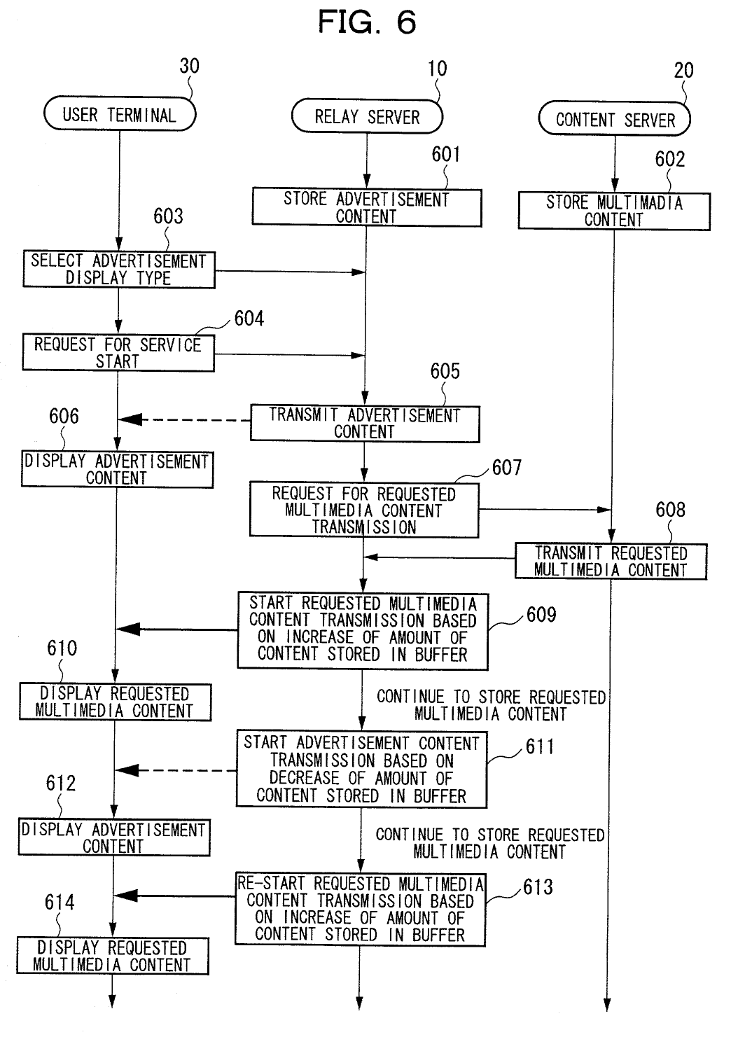

Next, operations of the fourth embodiment are described in detail with reference to the figure, below. FIG. 6 is a flowchart for explaining advertisement content providing processing according to the fourth embodiment of the present invention.

Referring to FIG. 6, the relay server 10a has data of advertisement content previously stored in the advertisement content storing section 12 (step 601), and the content server 20 has data of image content previously stored in the image content storing section 21 (step 602).

First, a user designates an advertisement display type from the user terminal 30 to the relay server 10a (step 603). Hereafter is described processing in which an advertisement display type such that image content and advertisement content are alternatively switched to be displayed is designated. Next, the user transmits a service starting request of image content distribution from the user terminal 30 to the relay server 10a (step 604). When the relay server 10a receives the service starting request, the relay server transmits to the user terminal 30 previously-stored advertisement content stored in the advertisement content storing section 12 and makes the user terminal to display the image content (step 605, step 606).

At the same time, the relay server 10a requests the content server 20 to transmit image content (step 607). When the content server 20 receives a transmission request from the relay server 10a, the content server 20 transmits the image content to the relay server 10a via the global network 51 (step 608).

Then, When amount of the image content stored in the buffer 15 of the relay server 10a reaches a predetermined value, the relay server 10a starts to transmit the stored content to the user terminal 30 (step 609). Thereby, the user terminal 30 receives the image content and starts playback of the content (step 610).

Further, during transmission of the image content from the relay server 10a to the user terminal 30, when the data amount of the image content stored in the buffer 15 is less than the predetermined data amount (or the stored data falls short), transmission of the image content from the relay server 10a to the user terminal 30 is switched to transmission of the advertisement content so as to display the advertisement content (step 611, step 612).

The relay server 10a continuously downloads the image content from the content server 20 during the transmission of the advertisement content. When the amount of the image content stored in the buffer 15 reaches a predetermined value, the relay server 10a starts to transfer the image content and makes the user terminal 30 to play the image content again (step 613, step 614)

As described above, the content distribution system of the present embodiment can show the same effects as those of the first embodiment. Further, in the present embodiment, the relay server 10a is not required to have a scheduler 11. Therefore, the relay server can be configured by a simpler apparatus configuration.

In the fourth embodiment of the present invention, switching of playback from the advertisement content to the image content and playback from the image content to the advertisement content is carried out based on the amount of the image content stored in the buffer 15. Therefore, when a high-speed communication line is used, playback of image content is not interrupted. In this case, playback of advertisement content is performed only before playback of the image content starts.

(Fifth Embodiment)

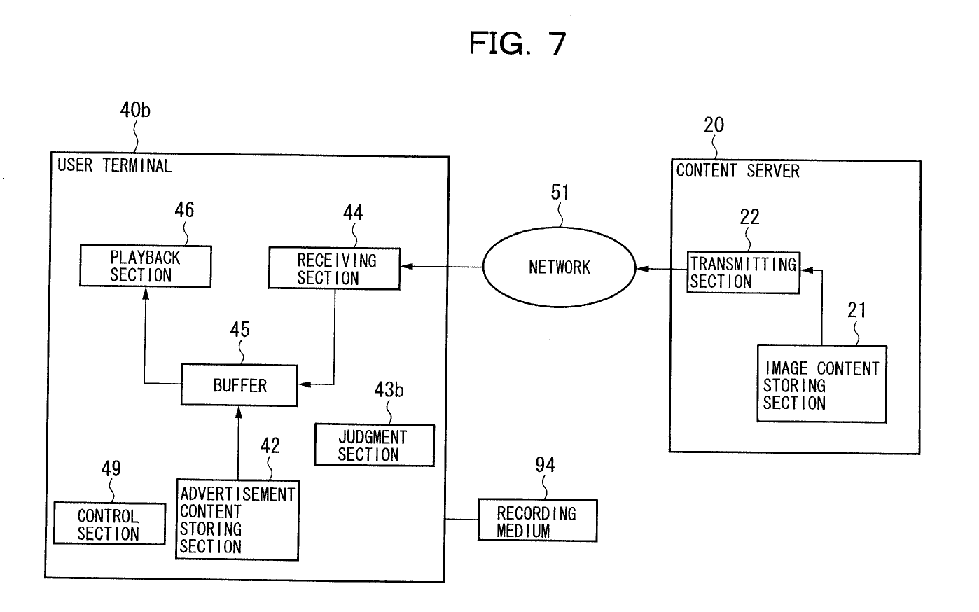

Next, the fifth embodiment of the present invention is described. FIG. 7 is a block diagram illustrating a content distribution system according to the fifth embodiment of the present invention. In this embodiment, a user terminal 40b has a function of the relay server 10a of the fourth embodiment, and executes the aforementioned processing of storing of image content and switching of played content.

In addition, like the relay server 10a of the fourth embodiment, the user terminal 40b of the present embodiment comprises the advertisement content storing section 42 and a judgment section 43 for selecting and switching content to be played. Processing of switching content to be playback in the user terminal 40b of the present embodiment is the same as that in the relay server 10a of the fourth embodiment.

That is, in the fifth embodiment, the judgment section 43b of the user terminal 40b controls the switching of the content to be playback based on the amount of image content stored in the buffer 45.

(Sixth Embodiment)

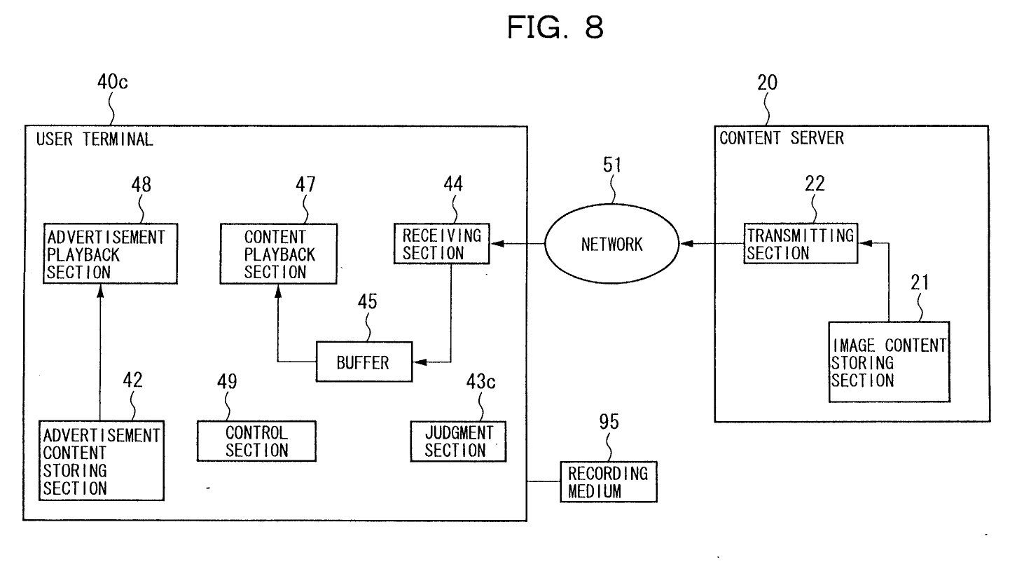

Next, a sixth embodiment of the present invention is described. FIG. 8 is a block diagram illustrating a content distribution system according to the sixth embodiment of the present invention. In this embodiment, a user terminal 40c comprises an advertisement displaying section 48 which is a displaying section dedicated for displaying the advertisement content stored in the advertisement content storing section 42. That is, in the sixth embodiment, it is assumed that the image content and advertisement content are displayed using respective different applications.

In the sixth embodiment of the present invention, the judgment section 43c provided in the user terminal 40c controls switching of the display of the advertisement content stored in the advertisement content storing section 42 and the image content stored in the buffer 45 which is transferred via a global network 51, based on the amount of the image content stored in a buffer 45.

In the aforementioned fifth and sixth embodiments of the present invention, the same effects as those in the fourth embodiment are expected. Further, it is not necessary to place the relay server on the communication network.

(Seventh Embodiment)

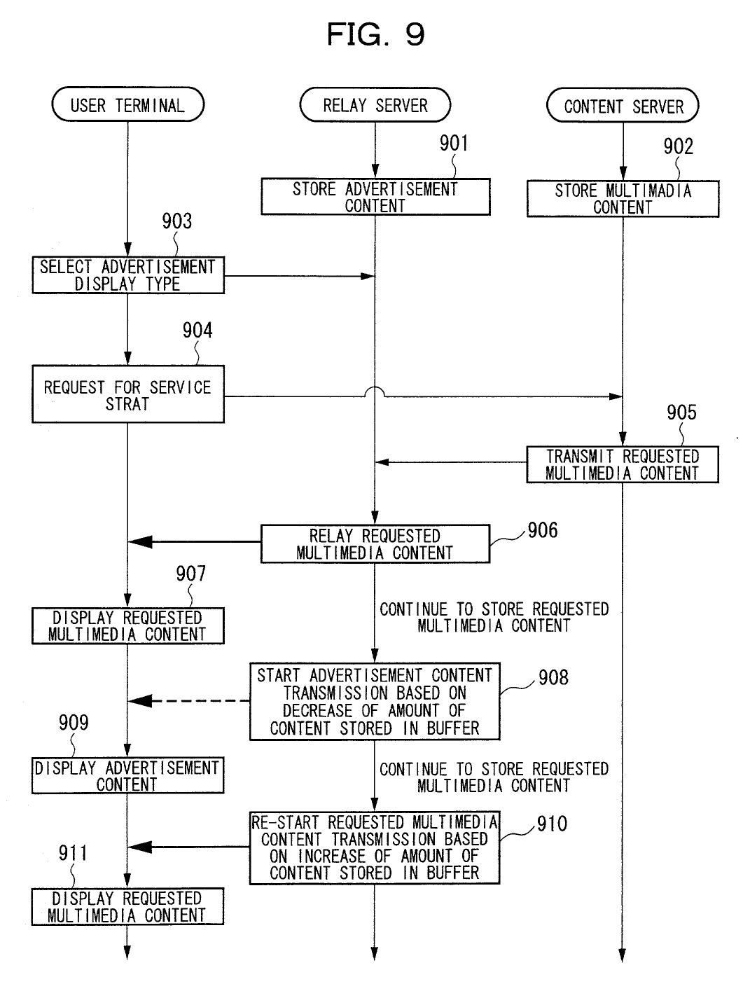

The seventh embodiment of the present invention is described. FIG. 9 is a flowchart for illustrating advertisement content providing processing according to the seventh embodiment of the present embodiment.

In the flowcharts shown in FIGS. 2 and 6 of respective first and fourth embodiments, the advertisement content is distributed from the relay server to the user terminal to be played before playback of the image content starts. However, the present invention is not limited to this type. In the present embodiment as shown in FIG. 9, the user terminal directly requests the content server to distribute image content (step 904). The relay server store the image content distributed from the content server, and when a predetermined stored amount of the image content is obtained, the relay server distributes the image content to the user terminal (step 906). In the present embodiment, the advertisement content is distributed only when distribution of the image content is interrupted (step 908). This is a type such that the advertisement content is not distributed to the user terminal before distribution of the image content, which can be carried out in the same manner as that in the foregoing first embodiment.

In the content distribution systems of the present invention functions of relay the servers 10 and 10a of the first, fourth and seventh embodiments, functions of the schedulers 41, 41a, 41b and 41c and the judgment section 43, 43a 43b and 43c in the user terminals 40, 40a, 40b and 40c of the second, third, fifth and sixth embodiment, and other functions can be realized not only by being incorporated in the hardware, but also by loading a content distribution program, which is a computer program with each function, in a memory of a computer processing apparatus. This content distribution program is stored in a recording medium 90, 91, 92, 93, 94 or 95 such as a magnetic discs, a semiconductor memory or the like. Then the content distribution program is loaded from recording medium onto the computer processing apparatus, thereby realizing each of the aforementioned functions.

The present invention has been described with reference to the preferred embodiments and examples. However, the present invention should not intend to be limited to the above-mentioned embodiments and examples. The present invention can be subject to various modifications to be carried out so far as they fall within its technical idea.

As described above, the following effects are achieved by the content distribution system of the present invention.

Firstly, according to the present invention, it is easy to reserve a time for inserting advertisement content between contents to be distributed to a user. In particular, it is possible to perform not banner advertising but display of advertisement content using whole the screen, thereby realizing the same advertising effects as those shown in cinemas.

Secondly, according to the present invention, it is possible to store in a buffer image content distributed from a server by utilizing a time for displaying previously-stored advertisement content. This allows efficient usage of communication networks. In addition, it is easy for a communication distributor to assure the quality of communication networks all the time.

Thirdly, according to the present invention, it is possible to store advertisement content in a relay server or user terminal to provide the same, thereby allowing to rich and large volume of advertisement content be provided.

Fourthly, according to the present invention, it is possible for a user to view both of the advertisement content and the distributed image content with high quality. In addition, by charging a part of cost required for offering an image content service to an advertising provider, the user can enjoy the service at a low price.

Fifthly, according to the present invention, a relay server can be used as a mirror server by local-caching popular content.

What is claimed is:

1. A multimedia content distribution system in which a multimedia content requested from a user terminal is distributed from a content server to said user terminal, wherein said system having a relay server which receives a first multimedia content distributed from said content server in accordance with a request from said user terminal and transmits said received first content to said user terminal;
said relay server comprising:
a first content storing means for temporally storing said first content received from said content server;
a monitoring means for monitoring whether or not a data amount of said received first content stored in said first content storing means is beyond a predetermined data amount;
a second content storing means having a second multimedia content at least including an advertising content; and
a control means for controlling said relay server so as to transmit said first content stored in said first content storing means to said user terminal in a case in which said monitoring means detects that a data amount of said first content is beyond a predetermined amount, and controlling said relay server so as to transmit said second content stored in said second content storing means to said user terminal in a case in which said monitoring means detects that a data amount of said first content stored in said first content storing means is less than said predetermined amount.

2. The multimedia content distribution system according to claim 1, wherein said relay server further comprising a scheduler for managing distribution of said second content stored in said second content storing means, said control means transmits said second content to said user terminal in accordance with an instruction output from said scheduler.

3. The multimedia content distribution system according to claim 1, wherein said relay server further comprising a scheduler for managing distribution of said second content stored in said second content storing means, said control means transmits periodically said second content to said user terminal in accordance with an instruction output from said scheduler.

4. The multimedia content distribution system according to claim 1, wherein said relay server and said user terminal are connected via a local area network.

5. A multimedia content receiving system in which a user terminal receives multimedia content distributed from a content server in accordance with a request from said user terminal, said user terminal comprising:
a first content storing means for temporally storing a first multimedia content received from said content server;
a monitoring means for monitoring whether or not a data amount of said received first content stored in said first content storing means is beyond a predetermined data amount;
a second content storing means for storing a second multimedia content at least including an advertising content; and
a control means for controlling said user terminal so as to display said first content stored in said first content storing means on said user terminal in a case in which said monitoring means detects that a data amount of said first content is beyond a predetermined amount, and controlling said user terminal so as to display said second content stored in said second content storing means on said user terminal in a case in which said monitoring means detects that a data amount of said first content stored in said first content storing means is less than said predetermined amount.

6. The multimedia content receiving system according to claim 5, wherein said user terminal further comprising a scheduler for managing display of said second content stored in said second content storing means, said control means controls display of said second content in accordance with an instruction output from said scheduler.

7. The multimedia content receiving system according to claim 5, wherein said user terminal further comprising a scheduler for managing display of said second content stored in said second content storing means, said control means controls so as to display periodically said second content in accordance with an instruction output from said scheduler.

8. A server apparatus comprising:
a content receiving means for receiving a first multimedia content distributed via a first communication network;
a first content storing means for temporally storing said first content received by said content receiving means;
a monitoring means for monitoring whether or not a data amount of said first content stored in said first content storing means is beyond a predetermined data amount;
a second content storing means for storing a second multimedia content at least including an advertising content;
a content transmitting means for transmitting said first or second content to a second communication network; and
a control means for controlling said content transmitting means so as to transmit said first content stored in said first content storing means to said second communication network in a case in which said monitoring means detects that a data amount of said first content is beyond a predetermined data amount, and controlling said content transmitting means so as to transmit said second content stored in said second content storing means to said second communication network in a case in which said monitoring means detects that a data amount of said first content stored in said first content storing means is less than said predetermined data amount.

9. A computer apparatus comprising:
a content receiving means for receiving a first multimedia content distributed via a communication network;
a first content storing means for temporally storing said first content received by said content receiving means;
a monitoring means for monitoring whether or not a data amount of said first content stored in said first content storing means is beyond a predetermined data amount;
a second content storing means for storing a second multimedia content at least including an advertising content; and
a control means for controlling said computer apparatus so as to display said first content stored in said first content storing means on said computer apparatus in a case in which said monitoring means detects that a data amount of said first content is beyond a predetermined data amount, and controlling said computer apparatus so as to display said second content stored in said second content storing means on said computer apparatus in a case in which said monitoring means detects that a data amount of said first content stored in said first content storing means is less than a predetermined data amount.

10. A multimedia content distribution method in which a multimedia content requested from a user terminal is distributed from a content server to said user terminal via a relay server, said method comprising the steps of:
receiving a first multimedia content distributed from said content server in said relay server;
storing said first content received from said content server in a first memory provided in said relay server temporally;
monitoring whether or not a data amount of said first content stored in said first memory is beyond a predetermined data amount; and
transmitting said first content stored in said first memory to said user terminal in a case in which a data amount of said first content is beyond a predetermined data amount in said monitoring step, and transmitting a second multimedia content stored previously in a second memory provided in said relay server to said user terminal in a case in which a data amount of said first content stored in said first memory is less than said predetermined data amount.

11. The multimedia content distribution method according to claim 10, wherein the step of storing said first content received from said content server in said first memory and the step of transmitting said first content or second content to said user terminal are performed simultaneously.

12. A multimedia content display method for receiving multimedia content distributed from a content server and displaying said received multimedia content on a user terminal, in accordance with a request from said user terminal, said method comprising the steps of:
receiving a first multimedia content distributed from said content server;
storing a first content received from said content server in a first memory provided in said user terminal temporally;
monitoring whether or not a data amount of said first content stored in said first memory is beyond a predetermined data amount; and
displaying said first content stored in said first memory on said user terminal in a case in which a data amount of said first content is beyond a predetermined data amount in said monitoring step, and displaying second multimedia content stored previously in a second memory provided in said user terminal in a case in which a data amount of said first content stored in said first memory is less than said predetermined amount.

13. The method according to claim 12, wherein the step of storing said first content received from said content server in said first memory and the step of displaying said first content or second content on said user terminal are performed simultaneously.

14. A computer program for a multimedia content distribution system in which a multimedia content requested from a user terminal is distributed from a content server to said user terminal via a relay server, wherein said computer program causing said relay server to execute a sequential processing comprising the steps of:
receiving a first multimedia content distributed from said content server in said relay server;
storing said first content received from said content server in a first memory provided in said relay server temporally;
monitoring whether or not a data amount of said first content stored in said first memory is beyond a predetermined data amount; and
transmitting said first content stored in said first memory to said user terminal in a case in which a data amount of said first content is beyond a predetermined data amount in said monitoring step, and transmitting a second multimedia content stored previously in a second memory provided in said relay server to said user terminal in a case in which a data amount of said first content stored in said first memory is less than said predetermined data amount.

15. A computer program for receiving multimedia content distributed from a content server and displaying said received multimedia content on a user terminal, in accordance with a request from said user terminal, wherein said computer program causing said user terminal to execute a sequential processing comprising the steps of:
receiving a first multimedia content distributed from said content server;
storing a first content received from said content server in a first memory provided in said user terminal temporally;
monitoring whether or not a data amount of said first content stored in said first memory is beyond a predetermined data amount; and
displaying said first content stored in said first memory on said user terminal in a case in which a data amount of said first content is beyond a predetermined data amount in said monitoring step, and displaying second multimedia content stored previously in a second memory provided in said user terminal in a case in which a data amount of said first content stored in said first memory is less than said predetermined amount.
